(19) United States
(12) Patent Application Publication
(10) Pub. No.: US 2016/0154868 A1
(43) Pub. Date: Jun. 2, 2016

(54) DATA SYNCHRONIZING SYSTEM

(71) Applicants: Inventec (Pudong) Technology Corporation, Shanghai (CN); INVENTEC CORPORATION, TAIPEI CITY (TW)

(72) Inventors: Ming-Hsiao HSIEH, TAIPEI CITY (TW); Chih-Chin YANG, TAIPEI CITY (TW)

(21) Appl. No.: 14/684,438

(22) Filed: Apr. 13, 2015

(30) Foreign Application Priority Data
Nov. 27, 2014 (CN) 201410707569.1

(51) Int. Cl. G06F 17/30; H04L 12/863; H04L 29/08

(52) U.S. Cl. CPC G06F 17/30575; H04L 67/1095; H04L 47/62

(57) ABSTRACT

A data synchronizing system includes a plurality of data centers and a data synchronizing controller. The data synchronizing controller is communicatively coupled to the data centers for outputting a synchronizing command and a synchronizing parameter to the data centers periodically. One of the data centers adjusts a data transmitting condition thereof based on the synchronizing parameter so as to synchronize data to another one of the data centers such that each of the data centers has the same data.

### RELATED APPLICATIONS

This application claims priority to Chinese Application Serial Number 201410707569.1, filed Nov. 27, 2014, which is herein incorporated by reference.

### BACKGROUND

1. Field of Invention

The present invention relates to data synchronizing technology. More particularly, the present invention relates to a data synchronizing system.

2. Description of Related Art

For an international company, data management of branches of the company in many countries is complex. A typical management scheme involves setting up many data centers for sharing data so as to enhance response speed and reduce the utilization of network bandwidth. In this situation, if the amount of data is extremely large and the network bandwidth cannot process the data, a number of problems will be encountered. For example, with respect to an overwriting mechanism or directly backing up original data in a data center during initialization, it is necessary to restore data to an offsite data center before such methods can be used. Disconnecting for a long time is such that a synchronizing mechanism cannot be restored, and the synchronizing mechanism must be initialized. Moreover the amount of data cannot be transmitted effectively according to the network bandwidth. Also, during initialization of an overwriting mechanism or backing up original data in a data center, access by users is not possible for a short period.

In view of the foregoing, problems and disadvantages are associated with existing products that require further improvement. However, those skilled in the art have yet to find a solution.

### SUMMARY

The following presents a simplified summary of the disclosure in order to provide a basic understanding to the reader. This summary is not an extensive overview of the disclosure and it does not identify key/critical elements of the present invention or delineate the scope of the present invention.

One aspect of the present disclosure is directed to a data synchronizing system. The data synchronizing system includes a plurality of data centers and a data-synchronizing controller. The data-synchronizing controller is communicatively coupled to the data centers for outputting a synchronizing command and a synchronizing parameter to the data centers periodically. One of the data centers adjusts a data transmitting condition thereof based on the synchronizing parameter so as to synchronize data to another one of the data centers such that each of the data centers has the same data

In view of the foregoing, embodiments of the present disclosure provide a data synchronizing system. It is apparent that the application of the present invention has a number of advantages as follows: (1) adjusting data synchronizing parameters according to a result of a former synchronizing process and present network performance in order to enhance network bandwidth efficiency; (2) achieving offsite data synchronization by using minimum network bandwidth; (3) decreasing the chance of users requesting the same data to thereby reduce the occupation of network bandwidth; (4) adding data to an offsite data center, and not overwriting data to the offsite data center, so as to solve the problem of data difference between old and new versions, in which the version can be identified by the data synchronizing system automatically; (5) enabling users to access data during the data synchronizing process.

These and other features, aspects, and advantages of the present invention, as well as the technical means and embodiments employed by the present invention, will become better understood with reference to the following description in connection with the accompanying drawings and appended claims.

### BRIEF DESCRIPTION OF THE DRAWINGS

The invention can be more fully understood by reading the following detailed description of the embodiment, with reference made to the accompanying drawings as follows:

FIG. 1 is a schematic diagram of a data synchronizing system according to embodiments of the present invention.

FIG. 2 is a schematic diagram of a data synchronizing system according to embodiments of the present invention.

FIG. 3 is an operation diagram of a data synchronizing system as shown in FIG. 2 according to embodiments of the present invention.

FIG. 4 is a schematic diagram of a data synchronizing system according to embodiments of the present invention.

FIG. 5 is an operation diagram of a data synchronizing system as shown in FIG. 4 according to embodiments of the present invention.

In accordance with common practice, the various described features/elements are not drawn to scale but instead are drawn to best illustrate specific features/elements relevant to the present invention. Also, wherever possible, like or the same reference numerals are used in the drawings and the description to refer to the same or like parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include singular forms of the same.

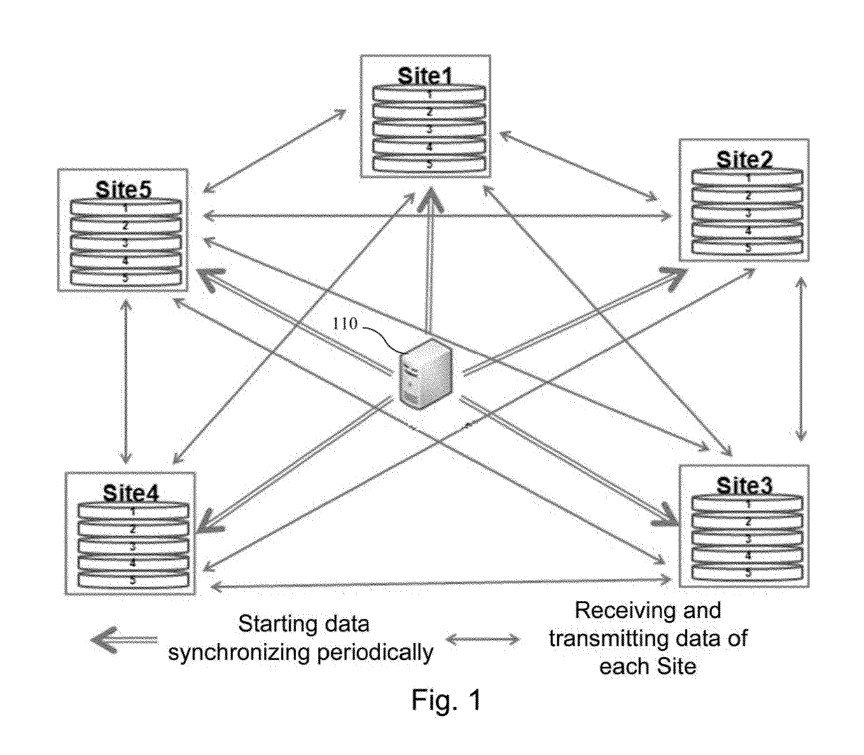

FIG. 1 is a schematic diagram of a data synchronizing system according to embodiments of the present invention. As shown in FIG. 1, the data synchronizing system includes a plurality of data centers Site1˜Site5 and a data synchronizing controller 110, The data synchronizing controller 110 is communicatively coupled to the data centers Site1˜Site5, and the data synchronizing controller 110 outputs a synchronizing command and a synchronizing parameter to the data centers Site1˜Site5 periodically, such that one of the data centers (for example, Site1) adjusts a data transmitting condition thereof based on the synchronizing parameter so as to synchronize data to another one of the data centers for example, Site2), such that each of the data centers Site1˜Site5 has the same data.

For example, the data synchronizing controller 110 can output the synchronizing command and the synchronizing parameter to the data centers Site1˜Site5 periodically. The data center Site1 adjusts the data transmitting condition thereof based on the synchronizing parameter so as to synchronize data to the data center Site2. The data center Site2 can use a similar technique to synchronize data to the data center Site1. Moreover, the other data centers Site3˜Site5 can use a similar technique to synchronize data to each other, such that each of the data centers Site1˜Site5 has the same data. As shown in the figure, the data center Site1 has data of the data centers Site1˜Site5, the data center Site2 also has data of the data centers Site1˜Site5, and each of the data centers Site3˜Site5 also has data of the data centers Site1˜Site5.

In view of above, since each of the data centers Site1˜Site5 has all the data of all the data centers Site1˜Site5, if users need to access data, users can access the data quickly from a local site data center. Furthermore, since each of the data centers Site1˜Site5 can adjust a data transmitting condition based on the synchronizing parameter so as to synchronize data to each other, the data synchronizing system can adjust data synchronizing parameters according to a result of a former synchronizing process and network performance for enhancing network bandwidth efficiency and achieving offsite data synchronization by using minimum network bandwidth. Moreover, since each of the data centers Site1˜Site5 has all the data of all the data centers Site1˜Site5, if users need to access data, users can access the data center located in the same area or the same country with users to obtain data which users need to thereby decrease the chance of users requesting the same data so as to ultimately reduce the occupation of network bandwidth.

In another embodiment, the synchronizing parameter is set according to the data transmitting condition of one of the data centers (for example, Site1) synchronizing data to another one of the data centers (for example, Site2). In yet another embodiment, one of the data centers (for example, Site1) adjusts the synchronizing parameter according to a former data transmitting condition, and synchronizes data to another one of the data centers (for example, Site2) according to the adjusted synchronizing parameter. For example, the data synchronizing system of the present invention can adjust the data synchronizing parameter according to a result of a former synchronizing process and network performance to synchronize data among data centers Site1˜Site5 for enhancing network bandwidth efficiency.

In still another embodiment, if one of the data centers (for example, Site1) needs to synchronize a transmitted data in a former synchronizing process to another one of the data centers (for example, Site2), one of the data centers (for example, Site1) adds the transmitted data in the former synchronizing process to another one of the data centers (for example, Site2). Hence, the same data will be added to an offsite data center, and not overwritten to the offsite data center to thereby solve the problem of data difference between old and new versions. Moreover, users can access data during the data synchronizing process. The version can be identified by the data synchronizing system automatically.

In another embodiment, one of the data centers (for example, Site1) synchronizes a plurality of data to another one of the data centers (for example, Site2) sequentially, and stores a first data sequence number of a last synchronizing data which is synchronized to another one of the data centers in a former synchronizing process. Subsequently, in this synchronizing process, one of the data centers (for example, Site1) synchronizes data with a second sequence number following the first data sequence number to another one of the data centers (for example, Site2).

For example, the data center Site1 sends out a data synchronizing request to the data center Site2 according to a parameter which is automatically adjusted by the former synchronized result of the data center Site2. The data center Site2 receives the synchronizing parameter of the data center Site1 so as to obtain a synchronizing parameter which is used in this synchronizing process, and synchronizes data to the data center Site1 according to another data sequence number following the data sequence number in the former synchronizing process. For example, if the data sequence number of the last synchronized data in the former synchronizing process is 40, one of the data centers synchronizes data with data sequence number 41, 42, 43 to another one of the data centers. After the synchronizing process, the data center Site1 can adjust a parameter for the next synchronizing process according to synchronized time, amount of the synchronized data, network bandwidth, and number of synchronized data. In another embodiment, the data synchronizing system can perform a data synchronizing process in an off-peak time For example, the data synchronizing system can perform a data synchronizing process at nigh and thereby avoid occupation of network bandwidth.

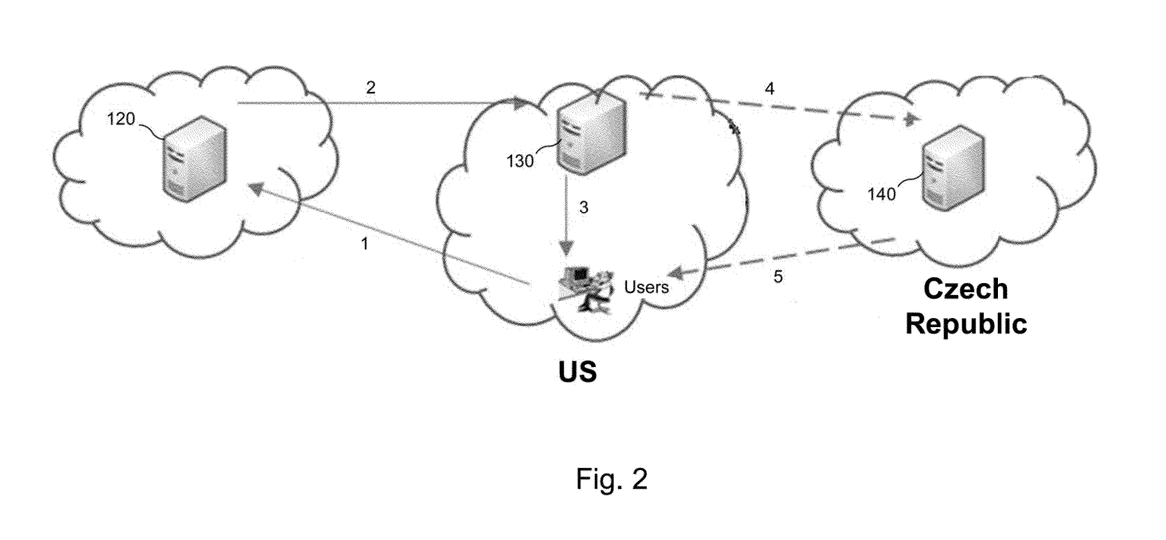

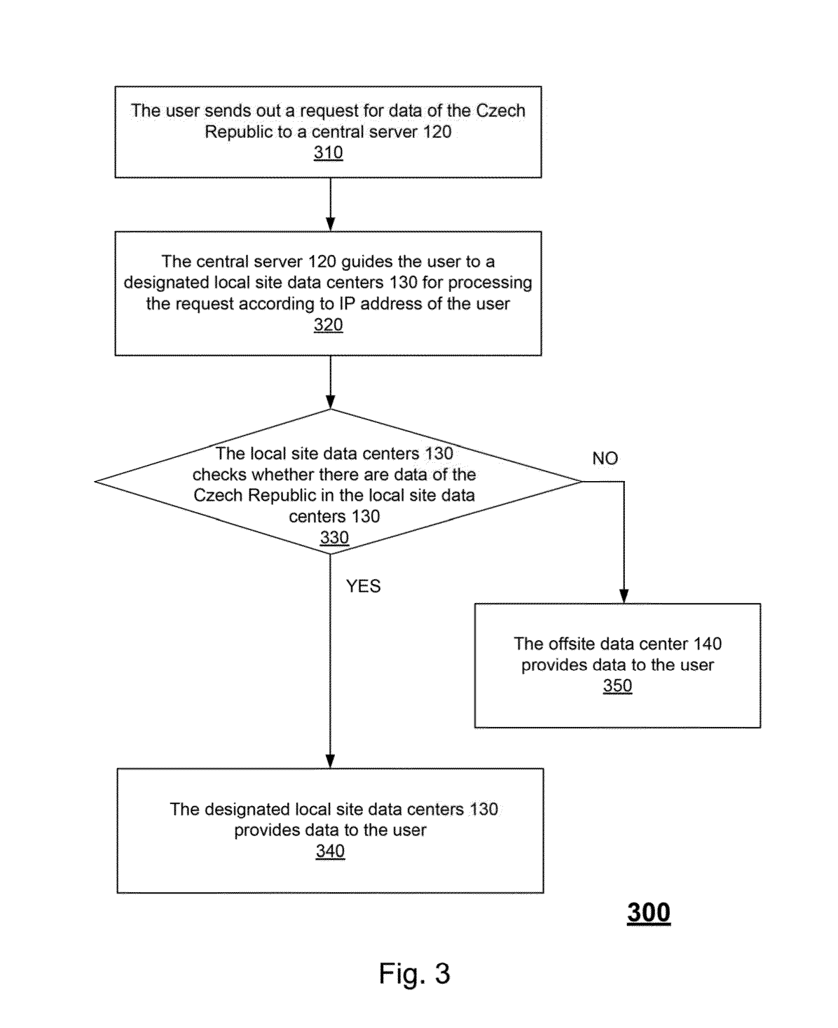

FIG. 2 is a schematic diagram of a data synchronizing system according to embodiments of the present invention. FIG. 3 is an operation diagram of a data synchronizing system as shown in FIG. 2 according to embodiments of the present invention. Compared with FIG. 1, the data synchronizing system of FIG. 2 further includes a central server 120, a local site data center 130 and an offsite data center 140. If the central server 120 receives a data access request from a user, the central server 120 guides the user to the local site data center 130 of the data centers according to the location of the user.

For facilitating understanding of the operations of the present invention, reference is now made to both FIG. 2 and FIG. 3. Assuming the user is in the US, and the user needs data of the Czech Republic, the procedure is as described below.

Referring to arrow 1 of FIG. 2 and step 310 of FIG. 3, the user sends out a request for data of the Czech Republic to a central server 120. Subsequently, referring to arrow 2 of FIG. 2 and step 320 of FIG. 3, the central server 120 guides the user to a designated local site data center 130 for processing the request according to the IP address of the user. Finally, referring to arrow 3 of FIG. 2 and step 340 of FIG. 3, the designated local site data center 130 provides data to the user.

However, if all data of the data centers are not completely synchronized to each other, data of the Czech Republic which the user needs may not be stored in the local site data center 130. In this case, the procedure is as described below.

Referring to arrow 4 of FIG. 2 and step 330 of FIG. 3, the local site data center 130 checks whether there are data of the Czech Republic in the local site data center 130, and the request of the user is guided to the offsite data center 140 for processing the request if the local site data center 130 determines that there is no data of the Czech Republic in the local site data centers 130. Subsequently, referring to arrow 5 of FIG. 2 and step 350 of FIG. 3, the offsite data center 140 provides data to the user.

In one embodiment, the local site data center 130 is a data center located in the same area or the same country as the client. For example, both the client and the data center may be located in Asia or the US. In addition, the location of the client is an IP address.

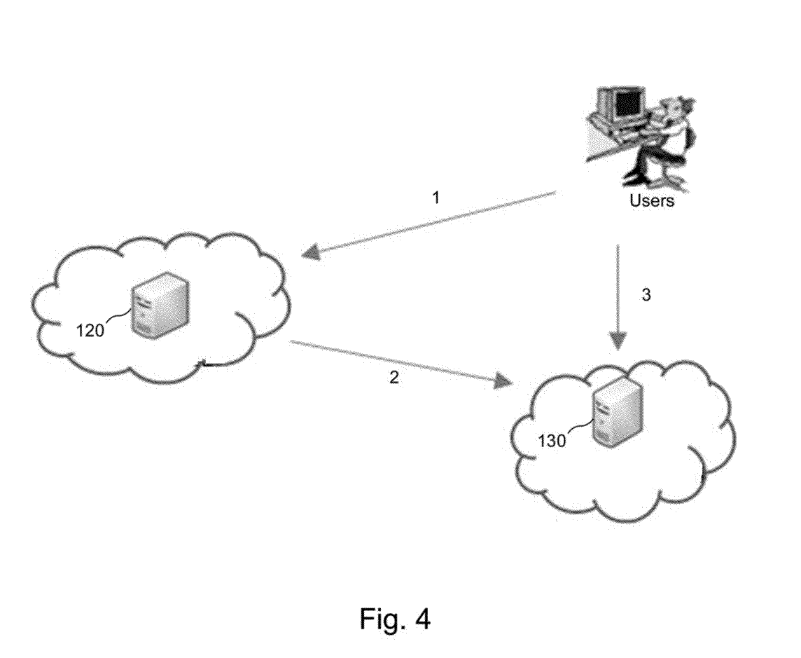

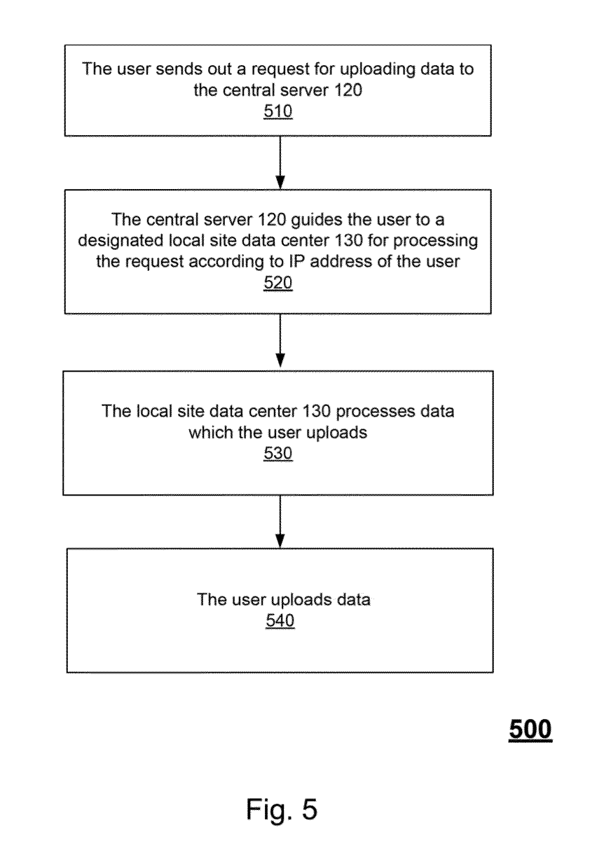

FIG. 4 is a schematic diagram of a data synchronizing system according to embodiments of the present invention. FIG. 5 is an operation diagram of a data synchronizing system as shown in FIG. 4 according to embodiments of the present invention. Compared with the data synchronizing system of FIG. 1, the data synchronizing system of FIG. 4 further includes a central server 120 and a local site data center 130. For facilitating understanding of operations of the present invention, reference is now made to both FIG. 4 and FIG. 5, and the procedure is as described below.

Referring to arrow 1 of FIG. 4 and step 510 of FIG. 5, the user sends out a request for uploading data to the central server 120. Subsequently, referring to arrow 2 of FIG. 4 and step 520 of FIG. 5, the central server 120 guides the user to a designated local site data center 130 for processing the request according to IP address of the user. Next, referring to arrow 3 of FIG. 4 and step 530 of FIG. 5, the local site data center 130 processes data which the user uploads. Finally, referring to step 540 of FIG. 5, the user uploads data.

In view of the foregoing, embodiments of the present disclosure provide a data synchronizing system. It is apparent that the application of the present invention has a number of advantages as follows: (1) adjusting data synchronizing parameters according to a result of a former synchronizing process and present network performance in order to enhance network bandwidth efficiency; (2) achieving offsite data synchronization by using minimum network bandwidth; (3) decreasing the chance of users requesting the same data to thereby reduce the occupation of network bandwidth; (4) adding data to an offsite data center, and not overwriting data to the offsite data center, so as to solve the problem of data difference between old and new versions, in which the version can be identified by the data synchronizing system automatically; (5) enabling users to access data during the data synchronizing process.

Although the present invention has been described in considerable detail with reference to certain embodiments thereof, other embodiments are possible. Therefore, the spirit and scope of the appended claims should not be limited to the description of the embodiments contained herein,

It will be apparent to those skilled in the art that various modifications and variations can be made to the structure of the present invention without departing from the scope or spirit of the invention, In view of the foregoing, it is intended that the present invention cover modifications and variations of this invention provided they fall within the scope of the following claims.

What is claimed is:

1. A data synchronizing system, comprising
a plurality of data centers; and
a data synchronizing controller communicatively coupled to the data centers for outputting a synchronizing command and a synchronizing parameter to the data centers periodically, wherein one of the data centers adjusts a data transmitting condition thereof based on the synchronizing parameter so as to synchronize data to another one of the data centers such that each of the data centers has the same data.

2. The data synchronizing system of claim wherein the synchronizing parameter is set according to the data transmitting condition of one of the data centers synchronizing data to another one of the data centers.

3. The data synchronizing system of claim 1, wherein one of the data centers adjusts the synchronizing parameter according to a former data transmitting condition, and synchronizes data to another one of the data centers according to the adjusted synchronizing parameter.

4. The data synchronizing system of claim 1, wherein if one of the data centers needs to synchronize a transmitted data in a former synchronizing process to another one of the data centers, one of the data centers adds the transmitted data in the former synchronizing process to another one of the data centers.

5. The data synchronizing system of claim 1, wherein one of the data centers synchronizes a plurality of data to another one of the data centers sequentially, and stores a first data sequence number of a last synchronizing data which is synchronized to another one of the data centers in a former synchronizing process, wherein in this synchronizing process, one of the data centers synchronizes data with a second sequence number following the first data sequence number to another one of the data centers.

6. The data synchronizing system of claim 1, wherein the synchronizing parameter comprises one of network bandwidth, number of synchronized data, and synchronized time.

7. The data synchronizing system of claim 1, further comprising a central server, wherein if the central server receives a data access request from a client, the central server guides the client to a local site data center of the data centers according to a location of the client.

8. The data synchronizing system of claim 7, wherein the local site data center is a data center located in the same area or the same country as the client.

9. The data synchronizing system of claim 7, wherein if the local site data center does not have data which the client needs, the central server guides the client to an offsite data center of the data centers which has the data the client needs according to data the client needs.

10. The data synchronizing system of claim 7, wherein the location of the client comprises an IP address of the client.
